(19) United States
(12) Patent Application Publication
(10) Pub. No.: US 2023/0147202 A1
(43) Pub. Date: May 11, 2023

(54) FACE RECOGNIZATION

(71) Applicant: BEIJING BAIDU NETCOM SCIENCE TECHNOLOGY CO., LTD., BEIJING (CN)

(72) Inventors: Bi LI, Beijing (CN); Nan PENG, Beijing (JP); Teng XI, Beijing (JP); Gang ZHANG, Beijing (JP)

(21) Appl. No.: 18/153,292

(22) Filed: Jan. 11, 2023

(30) Foreign Application Priority Data
Jan. 12, 2022 (CN) 202210032699.4

(51) Int. Cl. G06V 40/16; G06V 10/80; G06V 10/75

(52) U.S. Cl. CPC G06V 40/172; G06V 40/171; G06V 10/806; G06V 10/751

(57) ABSTRACT

A method for face recognition is disclosed. The method includes: obtaining an image to be recognized; extracting an image feature of the image to be recognized; obtaining a fused feature corresponding to a reference image of reference image; determining a similarity between the image feature of the image to be recognized and the fused feature corresponding to the reference image of the reference images to obtain a determination result of the similarity; and determining, based on the obtained determination result of the similarity, a face recognition result of the image to be recognized. It can be learned that recognition precision of a human face having a shielding object and a human face not having the shielding object may be ensured by means of this solution.

### CROSS-REFERENCE TO RELATED APPLICATIONS

This application claims priority to Chinese Patent Application No. 202210032699.4, filed on Jan. 12, 2022, titled METHOD AND APPARATUS FOR FACE RECOGNITION, DEVICE, AND STORAGE MEDIUM, the entire contents of which are hereby incorporated by reference.

### TECHNICAL FIELD

The present disclosure relates to the technical field of image processing, in particular to the field of face recognition, and specifically to a method and apparatus for face recognition, a device, and a storage medium.

### BACKGROUND

To recognize a human face having a shielding object, such as a human face having a mask, a feature comparison may be performed between an image to be recognized having the mask and a reference image in a database to determine a class of the image to be recognized, that is, to determine the human face in which reference image and the human face in the image to be recognized belong to the same person.

However, the reference image in the database is an image not having the shielding object. Therefore, there is a great feature difference between the image to be recognized having the shielding object and the reference image not having the shielding object.

### SUMMARY

The present disclosure provides a method for face recognition, a device, and a storage medium.

According to an aspect of the present disclosure, a method for face recognition is provided, including: obtaining an image to be recognized; extracting an image feature of the image to be recognized; obtaining a fused feature corresponding to a reference image of reference images, wherein the reference image of the reference images is a face image without a shielding object included, and wherein the fused feature corresponding to the reference image of the reference images is obtained by performing image feature fusion on the reference image and an enhanced image corresponding to the reference image, and the enhanced image corresponding to the reference image is obtained by arranging the shielding object in the reference image; determining a similarity between the image feature of the image to be recognized and the fused feature corresponding to the reference image of the reference images to obtain a determination result of the similarity; and determining, based on the obtained determination result of the similarity, a face recognition result of the image to be recognized.

According to an aspect of the present disclosure, an electronic device is provided, including: at least one processor; and a memory communicatively connected to the at least one processor, where the memory stores instructions executable by the at least one processor, where the instructions, when executed by the at least one processor, cause the at least one processor to perform the method for face recognition.

According to an aspect of the present disclosure, a non-transitory computer-readable storage medium storing computer instructions is provided, where the computer instructions, when executed by a computer, cause the computer to perform the method for face recognition.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the solutions, and do not constitute a limitation on the present disclosure. In the accompanying drawings:

FIG. 1 is a schematic diagram of face recognition having a shielding object in the related art;

FIG. 2 is a flowchart of a method for face recognition according to an embodiment of the present disclosure;

FIG. 3 is a schematic diagram of a method for face recognition according to an embodiment of the present disclosure;

FIG. 4 is a structural diagram of an apparatus for face recognition according to an embodiment of the present disclosure; and

FIG. 5 is a block diagram of an electronic device for implementing a method for face recognition according to an embodiment of the present disclosure.

### DETAILED DESCRIPTION

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described herein, without departing from the scope and spirit of the present disclosure. Likewise, for clarity and conciseness, the description of well-known functions and structures is omitted in the following description.

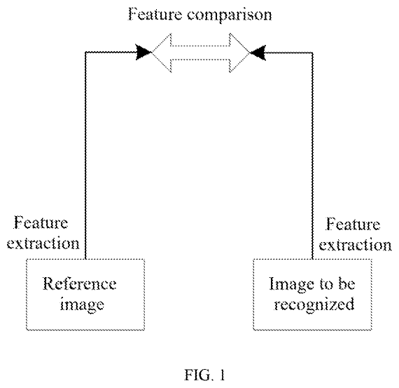

In a face recognition scenario having a shielding object, as shown in FIG. 1, taking the shielding object being a mask as an example, features of an image to be recognized having the mask and a reference image in a database are extracted respectively and compared to determine a class of the image to be recognized, that is, to obtain a face recognition result. The reference image in the database is a face image not having the mask, and there is a great feature difference between the image to be recognized having the mask and the reference image. Therefore, this method cannot ensure recognition precision of a face having the shielding object and a face not having the shielding object. Certainly, in addition to the mask, the shielding object may be a shielding object that affects the face recognition such as sunglasses and a cap.

A solution to the problem is that: in a training process of an image feature extractor, a reference image not having the shielding object is randomly selected, image enhancement processing is performed on the selected reference image, which means that the shielding object is added to the selected reference image, and then the reference image subjected to the image enhancement processing and a reference image not subjected to the image enhancement processing are used for training, so as to reduce the feature difference between the image having the shielding object and the image not having the shielding object. Inventors recognize that the above discussed method can only further improve extraction precision of an image feature. However, in the face recognition, the feature difference between the image to be recognized having the shielding object and the image not having the shielding object is actually not reduced effectively.

The present disclosure provides a method and apparatus for face recognition, a device, and a storage medium.

A description will be made below to a method for face recognition according to an example embodiment of the present disclosure.

The method for face recognition according to some embodiments of the present disclosure is applied to an electronic device. In implementations, the electronic device may be a server or a terminal device. The method for face recognition according to some embodiments of the present disclosure may include following steps: obtaining an image to be recognized; extracting an image feature of the image to be recognized; obtaining fused features corresponding to reference images, where each reference image is a face image not having a shielding object in a database, the fused feature corresponding to each reference image is obtained by performing image feature fusion on the reference image and an enhanced image corresponding to the reference image, and the enhanced image corresponding to the reference image is obtained by arranging the shielding object in the reference image; determining a similarity between the image feature of the image to be recognized and the fused features corresponding to the reference images to obtain a determination result of the similarity; and determining, based on the obtained determination result of the similarity, a face recognition result of the image to be recognized.

In the solution according to the present disclosure, during face recognition, a similarity analysis is performed based on the image feature of the image to be recognized and the fused feature corresponding to the reference image, so that the face recognition result of the image to be recognized may be determined based on a result of the similarity analysis. The fused feature corresponding to the reference image not only retains the image feature of the reference image not having the shielding object but also has the image feature of the enhanced image provided with the shielding object, so that: for the image to be recognized having the shielding object, the feature difference of the shielding object between the image to be recognized and the reference image may be reduced; and for the image to be recognized not having the shielding object, a feature commonality of not having the shielding object between the image to be recognized and the reference image may be ensured. Therefore, the recognition precision of the face having the shielding object and the face not having the shielding object may be ensured by means of this solution.

A description will be made below to the method for face recognition according to the present disclosure in conjunction with the accompanying drawings.

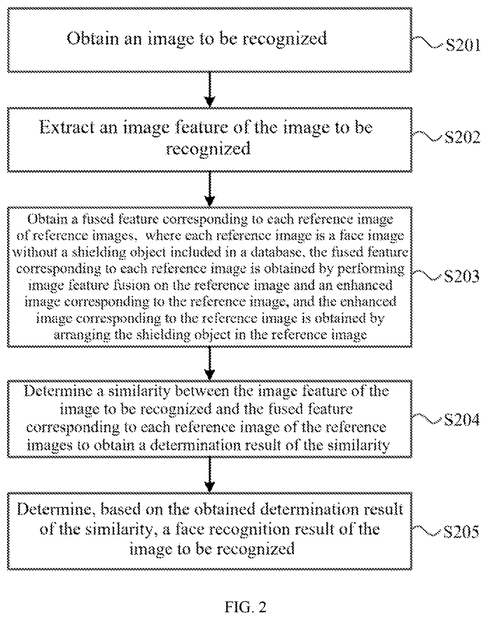

As shown in FIG. 2, the method for face recognition according to some embodiments of the present disclosure may include the following steps:

In S201, an image to be recognized is obtained.

The image to be recognized may be any one of images requiring face recognition, and the image to be recognized may be a face image having a shielding object, or may be a face image not having the shielding object. In some embodiments, the shielding object may include a mask, a cap, glasses, etc.

It can be understood that a plurality of manners may be used to obtain the image to be recognized.

In some embodiments, in an implementation, the obtaining an image to be recognized may include: obtaining an image to be recognized that is uploaded by an image acquisition device. In this case, the image to be recognized is a face image acquired by the image acquisition device, and after acquiring the image to be recognized, the image acquisition device may upload the image to the electronic device immediately, or certainly may upload the image to the electronic device periodically, which are possible. In some embodiments, in an implementation, the obtaining an image to be recognized may include: obtaining a face image acquired by an image acquisition module of the electronic device as the image to be recognized.

In some embodiments, in an implementation, the obtaining an image to be recognized may include: obtaining a face image uploaded by a user through a specified image uploading interface as the image to be recognized.

It should be emphasized that the implementations for obtaining the image to be recognized are only used as examples, and should not constitute a limitation on the embodiments of the present disclosure.

In S202, an image feature of the image to be recognized is extracted.

In can be understood that the image feature is a corresponding feature or characteristic of a class of objects that is different from another class of objects, or a collection of the feature and characteristic. Each image has its own feature that can distinguish it from another class of images. Generally, a plurality of features of a class of objects or a plurality of classes of features of the class of objects may be combined to form a feature vector to represent the class of objects. The face recognition is actually a process of classification, to recognize the class of a certain image, it is required to distinguish the image from another different class of images. Therefore, an extracted feature may be used for distinguishing. Based on the description, to implement the face recognition, in some embodiments of the present disclosure, the image feature of the image to be recognized may be extracted after the image to be recognized is obtained.

There may be a plurality of implementations for extracting the image feature of the image to be recognized. In some embodiments, in an implementation, the electronic device may use a pre-trained image feature extractor to extract the image feature of the image to be recognized. In some embodiments, the image feature extractor may include an image feature extraction network, and the present disclosure does not limit a training process of the image feature extractor.

In some embodiments, in an implementation, the electronic device may obtain the image feature of the image to be recognized by means of local binary patterns (LBP), a texture histogram method, etc.

In S203, fused features corresponding to reference images are obtained, where each reference image is a face image not having a shielding object in a database, the fused feature corresponding to each reference image is obtained by performing image feature fusion on the reference image and an enhanced image corresponding to the reference image, and the enhanced image corresponding to the reference image is obtained by arranging the shielding object in the reference image.

The reference image is a face image not having the shielding object which is pre-stored in the database, and a class of each reference image corresponds to a person to which a face in the reference image belongs.

Since in a face recognition scenario, the image to be recognized may have the shielding object, or may not have the shielding object, for ensuring recognition precision of the face having the shielding object and the face not having the shielding object, in the solution according to the present disclosure, the image features of the reference images are not obtained directly. Instead, the fused features corresponding to the reference images are obtained, so that the fused features corresponding to the reference images are subsequently used to perform a similarity analysis. It can be understood that to ensure comparability, a representation form of each of the fused features corresponding to the reference image is the same as a representation form of the image feature of the image to be recognized.

In addition, the reference image in the database mentioned in some embodiments is related to an actual use scenario, and collecting, storage, use, processing, transmitting, providing, disclosing, etc. of the reference image in the database all comply with related laws and regulations and are not against the public order and good morals.

It should be noted that there are a plurality of implementations for obtaining the fused features corresponding to the reference images.

In some embodiments, in an implementation, a fused image corresponding to the reference images may be pre-constructed. Therefore, during the face recognition, pre-constructed fused features corresponding to the reference images may be directly obtained. A higher recognition efficiency may be obtained by means of the implementation.

In an implementation, the fused features corresponding to the reference images may be constructed during the recognition. To make the solution and the arrangement clear, the implementation for obtaining the fused features corresponding to the reference images will be described later in conjunction with an embodiment. In addition, it should be noted that for the specific implementation for pre-constructing the fused image corresponding to the reference images, reference may be made to an implementation of how to construct the fused feature corresponding to the reference image described in another embodiment.

In S204, a similarity between the image feature of the image to be recognized and the fused features corresponding to the various reference images is determined to obtain a determination result of the similarity.

In some embodiments, the fused feature corresponding to the reference image is used to perform the similarity analysis. In the fused feature, both the image feature of the reference image not having the shielding object and the feature of the enhanced image provided with the shielding object are retained, so that: for the image to be recognized having the shielding object, the feature difference of the shielding object between the image to be recognized and the reference image may be reduced; and for the image to be recognized not having the shielding object, a feature commonality of not having the shielding object between the reference image and the image to be recognized may be ensured.

The determination result of the similarity includes: the similarity between the image feature of each reference image and the image feature of the image to be recognized, that is, a facial similarity between each reference image and the image to be recognized. In addition, the similarity may be represented by a distance between similarity degrees or features, which is proper.

In some embodiments, in an implementation, the image feature of the image to be recognized and the fused features corresponding to the reference images are represented in a form of a vector. Therefore, during the similarity analysis, a distance between the image feature of the image to be recognized and the fused feature corresponding to each reference image may be calculated, so that the determination result of the similarity may be determined based on the calculated distance. In some embodiments, the distance between the features may include a Euclidean distance, a cosine distance, etc.

In S205, a face recognition result of the image to be recognized is determined based on the obtained determination result of the similarity.

When the similarity is represented by the similarity degree, after the determination result of the similarity is determined, a target fused feature with the highest similarity degree may be determined from fused features whose similarity degree is larger than a predetermined threshold of the similarity degree; and person information of the reference image corresponding to the target fused feature is used as the face recognition result of the image to be recognized. In some embodiments, the predetermined threshold of the similarity degree may be 90%, 92%, 95%, etc.

When the similarity is represented by the distance, after the determination result of the similarity is determined, a target fused feature with the shortest distance may be determined from fused features whose distance is smaller than a predetermined threshold of the distance; person information of the reference image corresponding to the target fused feature is used as the face recognition result of the image to be recognized.

In some embodiments, during face recognition, the image feature of the image to be recognized and the fused feature corresponding to the reference image are used to perform a similarity analysis, so that the face recognition result of the image to be recognized may be determined based on a result of the similarity analysis. The fused feature corresponding to the reference image not only retains the image feature of the reference image not having the shielding object but also has the image feature of the enhanced image provided with the shielding object, so that: for the image to be recognized having the shielding object, the feature difference of the shielding object between the image to be recognized and the reference image may be reduced; and for the image to be recognized not having the shielding object, a feature commonality of not having the shielding object between the image to be recognized and the reference image may be ensured. Therefore, the recognition precision of the human face having the shielding object and the human face not having the shielding object may be ensured by means of this solution.

In some embodiments of the present disclosure, the obtaining fused features corresponding to reference images may include A1 to A3:

In step A1, for each of the reference images, a first image feature of the reference image is obtained.

That is, the image feature of the reference image not having the shielding object is obtained as the first image feature, where the first image feature of the reference image may be pre-extracted, or may be extracted during the face recognition, which are proper. In addition, for an extraction manner of the first image feature of the reference image, reference may be made to the extraction manner of the image feature of the image to be recognized, and details are not described herein.

In step A2, a second image feature of the enhanced image corresponding to the reference image is obtained.

The enhanced image is an image obtained by providing the reference image with the shielding object based on to a class of the shielding object in an actual scenario, such as a mask, sunglasses, or a cap.

The second image feature of the enhanced image corresponding to the reference image may be pre-extracted, or may be extracted during the face recognition, which are proper.

When the second image feature of the enhanced image corresponding to the reference image is extracted during the face recognition, the obtaining a second image feature of the enhanced image corresponding to the reference image includes: generating the enhanced image corresponding to the reference image; and extracting the second image feature of the enhanced image corresponding to the reference image.

To obtain the image feature of the enhanced image corresponding to the reference image, after the reference image is obtained, the reference image may be provided with the shielding object based on the class of the shielding object in the actual scenario, so that the enhanced image corresponding to the reference image may be generated. Reference may be made to steps C1 to C3 below for a specific generation process.

In addition, for an extraction manner of the second image feature of the enhanced image corresponding to the reference image, reference may be made to the extraction manner of the image feature of the image to be recognized, and details are not described herein.

In step A3, weighted fusion is performed, based on a weight ratio, on the first image feature and the second image feature to obtain the fused feature corresponding to the reference image. The weight ratio can be predetermined or dynamically determined, and can be initially determined and continuously updated through machine learning and training. In the description herein, a predetermined weight ratio is used as an illustrative example for descriptive purposes only.

The predetermined weight ratio may be set based on an actual application scenario. When the first image feature and the second image feature are represented by vectors having the same dimension, a value of each corresponding dimension of the two vectors may be weighted and added. For example, weights of the first image feature and the second image feature are both set to 0.5, and the value of each corresponding dimension is multiplied by 0.5 and then mutually added to obtain the fused feature corresponding to the reference image. Reference may be made to steps B1 to B2 below for a specific setting method.

In some embodiments, during face recognition, the weighted fusion is performed, based on the predetermined weight ratio, on each first image feature and the corresponding second image feature to obtain the fused feature corresponding to the reference image. Therefore, an effective fused feature may be obtained, and it is not necessary to occupy a storage space for a long time to store the fused feature.

In some embodiments of the present disclosure, to meet different application scenarios, before the performing, based on a predetermined weight ratio, weighted fusion on the first image feature and the second image feature to obtain the fused feature corresponding to the reference image, the method for face recognition may further include steps B1 to B2:

In step B1, a target scenario for acquisition of the image to be recognized is determined, where the target scenario for acquisition is selected from at least one scenario for acquisition that is determined based on a wearing of the shielding object.

The target scenario for acquisition of the image to be recognized may be divided based on the wearing case of the shielding object. In some embodiments, various scenarios for acquisition may include: a scenario where the shielding object is worn and a scenario where the shielding object is not worn, where in the scenario where the shielding object is worn, most people may wear the shielding object, while in the scenario where the shielding object is not worn, a few people may wear the shielding object. Taking the sunglasses as an example, in a scenario with stronger light, a ratio of people wearing the sunglasses is higher, while the case is opposite in a scenario with weaker light. Scenarios for acquisition of images vary and possibilities of having shielding objects vary. Therefore, the weight ratio of the first image feature and the second image feature may be set based on the target scenario for acquisition of the image to be recognized, so that the fused feature may retain more feature content matching an actual feature of the image to be recognized.

In step B2, a target weight ratio corresponding to the target scenario for acquisition is determined from a preset correspondence between each scenario of the at least one scenario for acquisition and a weight ratio thereof, where a weight ratio corresponding to each scenario of the at least one scenario for acquisition is used to represent: a weight ratio of an image feature of each reference image to an image feature of the enhanced image of the reference image in the scenario for acquisition.

After the target scenario for acquisition is determined, the target weight ratio matching the target scenario for acquisition may be determined based on the correspondence, where different scenarios for acquisition correspond to different weight ratios, and the weight of an image feature of images corresponding to a personnel class with a higher proportion in the scenarios for acquisition is higher.

In some embodiments, the correspondence between the various scenarios for acquisition and the weight ratios may include: a first weight ratio for the scenario where the shielding object is worn, where in the first weight ratio, the weight of the second image feature of the enhanced image is higher than the weight of the first image feature of the reference image, for example: the weight of the second image feature of the enhanced image is 0.9, and the weight of the first image feature of the reference image is 0.1, or the weight of the second image feature of the enhanced image is 0.8, and the first image feature of the reference image is 0.2; and a second weight ratio for the scenario where the shielding object is not worn, where in the second weight ratio, the weight of the second image feature of the enhanced image is lower than the weight of the first image feature of the reference image, for example: the weight of the second image feature of the enhanced image is 0.1, and the weight of the first image feature of the reference image is 0.9, or the weight of the second image feature of the enhanced image is 0.2, and the first image feature of the reference image is 0.8.

Therefore, more features of the reference image or more features of the enhanced image may be retained by setting the weight ratio, so that the method for face recognition according to the present disclosure may better adapt to the various scenarios for acquisition, improving the recognition precision.

Accordingly, step A3 of performing, based on a predetermined weight ratio, weighted fusion on the first image feature and the second image feature to obtain the fused feature corresponding to the reference image may include: performing, based on the target weight ratio, weighted fusion on the first image feature and the second image feature to obtain the fused feature corresponding to the reference image.

In some embodiments, the predetermined weight ratio may be set based on the actual scenario for acquisition, so that the method for face recognition according to the present disclosure may better adapt to the various scenarios for acquisition, further improving the recognition precision.

In some embodiments of the present disclosure, the generating the enhanced image corresponding to the reference image may include steps C1 to C3:

In step C1, a region for placement of the shielding object in the reference image is located. That is, the region for placement of the shielding object in the reference image is located based on a type of the shielding object and a position of the shielding object on a face in an actual case. For example, when the shielding object is a mask, the region for placement of the mask is the lower part of the human face in the image, including a region of the entire mouth and nostril.

In step C2, a pixel content for the shielding object in a specified image is determined, where the specified image is an image including the shielding object.

In an implementation, a plurality of images including the shielding object may be collected in advance and stored in the database, and when needed, an image including the shielding object is selected as the specified image, and the pixel content for the shielding object in the specified image is determined.

In step C3, a pixel content in the region for placement in the reference image is replaced with the pixel content of the shielding object, to obtain the enhanced image corresponding to the reference image.

It can be understood that the process of steps C1 to C3 may be implemented by a pre-trained artificial intelligence model, thereby improving generation efficiency. Specifically, the region for placement of the shielding object in the reference image is located first by the artificial intelligence model, then the image including the shielding object is selected as the specified image, the pixel content for the shielding object in the specified image is extracted, and finally the pixel content in the region for placement in the reference image is replaced to obtain the enhanced image corresponding to the reference image.

In some embodiments, the region for placement of the shielding object in the reference image is located first; the pixel content for the shielding object in a specified image is determined, where the specified image is an image including the shielding object; and then the pixel content in the region for placement in the reference image is replaced with the pixel content of the shielding object, to obtain the enhanced image corresponding to the reference image. As can be seen, in the solution, the enhanced image corresponding to the reference image may be quickly obtained by replacing the pixel content to perform the subsequent feature fusion.

For ease of understanding, taking the mask as an example, description will be made below to the method for face recognition according to an embodiment of the present disclosure in conjunction with the schematic diagram shown in FIG. 3.

As shown in FIG. 3, first, a feature of an image to be recognized is extracted, where the image to be recognized may be a face image having a mask, or may be a face image not having the mask; meanwhile, mask enhancing is performed on each reference image, that is, a pixel of the mask is used to replace that of a corresponding position, and features of the reference image and a mask-enhanced image are extracted; then, a weight is set based on an actual situation of a scenario for acquisition, and the features of the reference image and the mask-enhanced image are fused to obtain fused features of various reference images; and finally, a determination result of a similarity between the fused features of the various reference images and the feature of the image to be recognized is determined, and a face recognition result of the image to be recognized is obtained based on the determination result of the similarity.

It can be learned that, in some embodiments, the determination result of the similarity between the fused features of the various reference images and the feature of the image to be recognized is determined. Since an image feature of the reference image not having a shielding object is retained in the fused features, for various images such as the images to be recognized having the shielding object as well as the images to be recognized not having the shielding object, a relatively high recognition precision may be ensured by means of this solution.

It should be emphasized that in the technical solutions of the present disclosure, collection, storage, use, processing, transmission, provision, disclosure, etc. of user personal information involved all comply with related laws and regulations and are not against the public order and good morals.

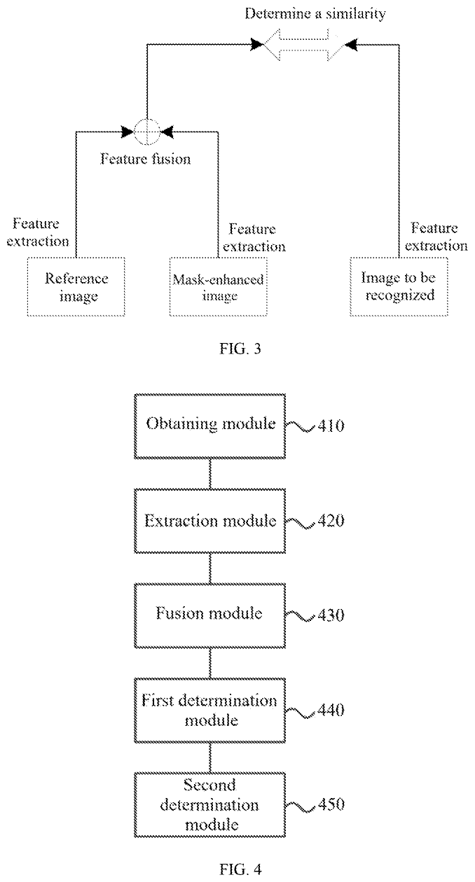

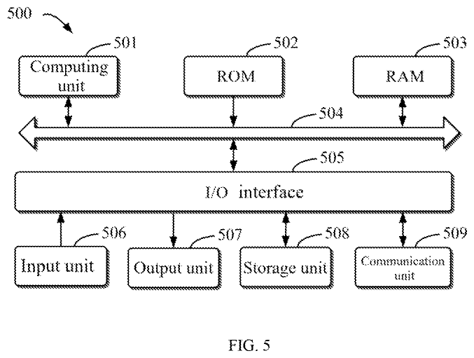

According to an aspect of the present disclosure, there is provided a face recognition apparatus, as shown in FIG. 4, the face recognition apparatus including: an obtaining module 410 configured to obtain an image to be recognized; an extraction module 420 configured to extract an image feature of the image to be recognized; a fusion module 430 configured to obtain fused features corresponding to reference images, where each reference image is a face image not having a shielding object in a database, the fused feature corresponding to each reference image is obtained by performing image feature fusion on the reference image and an enhanced image corresponding to the reference image, and the enhanced image corresponding to the reference image is an image after the reference image is provided with a shielding object; a first determination module 440 configured to determine a similarity between the image feature of the image to be recognized and the fused features corresponding to the reference images to obtain a determination result of the similarity; and a second determination module 450 configured to determine, based on the obtained determination result of the similarity, a face recognition result of the image to be recognized.

In some embodiments, the fusion module 430 includes: a first obtaining submodule configured to: for each of the reference images, obtain a first image feature of the reference image; a second obtaining submodule configured to obtain a second image feature of the enhanced image corresponding to the reference image; and a weighting submodule configured to perform, based on a predetermined weight ratio, weighted fusion on the first image feature and the second image feature to obtain the fused feature corresponding to the reference image.

In some embodiments, the second obtaining submodule includes: a generation unit configured to generate the enhanced image corresponding to the reference image; and an extraction unit configured to extract the second image feature of the enhanced image corresponding to the reference image.

In some embodiments, the generation unit includes: a locating subunit configured to locate a region for placement of the shielding object in the reference image; a determination subunit configured to determine a pixel content for the shielding object in a specified image, where the specified image is an image including the shielding object; and a replacement subunit configured to replace a pixel content in the region for placement in the reference image with the pixel content for the shielding object, to obtain the enhanced image corresponding to the reference image.

In some embodiments, the apparatus further includes: a scenario determination module configured to before the weighting submodule performs, based on the predetermined weight ratio, weighted fusion on the first image feature and the second image feature to obtain the fused feature corresponding to the reference image, determine a target scenario for acquisition of the image to be recognized, wherein the target scenario for acquisition is one of at least one scenario for acquisition, and each scenario of the at least one scenario for acquisition is obtained through division based on a wearing of the shielding object; and a weight determination module configured to determine, from a preset correspondence between each scenario of the at least one scenario for acquisition and a weight ratio thereof, a target weight ratio corresponding to the target scenario for acquisition, wherein a weight ratio corresponding to each scenario of the at least one scenario for acquisition represents: a weight ratio of an image feature of each reference image of the reference images to an image feature of the enhanced image of the reference image in the scenario for acquisition, the weighting submodule is specifically configured to perform, based on the target weight ratio, weighted fusion on the first image feature and the second image feature to obtain the fused feature corresponding to the reference image.

According to an embodiment of the present disclosure, the present disclosure further provides an electronic device, a readable storage medium, and a computer program product.

An electronic device according to an embodiment of the present disclosure includes: at least one processor; and a memory communicatively connected to the at least one processor, where the memory stores instructions executable by the at least one processor, where the instructions, when executed by the at least one processor, cause the at least one processor to perform the method for face recognition.

The present disclosure further provides a non-transitory computer-readable storage medium storing computer instructions, where the computer instructions are used to cause the computer to perform the method for face recognition.

The present disclosure further provides a computer program product including instructions, where the instructions when run on a computer, cause the computer to implement the steps of the method for face recognition in the foregoing embodiment.

FIG. 5 is a schematic block diagram of an example electronic device 500 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 5, the device 500 includes a computing unit 501, which may perform various appropriate actions and processing according to a computer program stored in a read-only memory (ROM) 502 or a computer program loaded from a storage unit 508 to a random access memory (RAM) 503. The RAM 503 may further store various programs and data required for the operation of the device 500. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, such as a keyboard or a mouse; an output unit 507, such as various types of displays or speakers; a storage unit 508, such as a magnetic disk or an optical disc; and a communication unit 509, such as a network interface card, a modem, or a wireless communication transceiver. The communication unit 509 allows the device 500 to exchange information/data with other devices through a computer network, such as the Internet, and/or various telecommunications networks.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described above, for example, the method for face recognition. For example, in some embodiments, the method for face recognition may be implemented as a computer software program, which is tangibly contained in a machine-readable medium, such as the storage unit 508. In some embodiments, a part or all of the computer program may be loaded and/or installed onto the device 500 via the ROM 502 and/or the communication unit 509. When the computer program is loaded onto the RAM 503 and executed by the computing unit 501, one or more steps of the method for face recognition described above can be performed. Alternatively or additionally, in other embodiments, the computing unit 501 may be configured, by any other suitable means (for example, by means of firmware), to perform the method for face recognition.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

The specific implementations above do not constitute a limitation on the protection scope of the present disclosure. Those skilled in the art should understand that various modifications, combinations, sub-combinations, and replacements can be made based on design requirements and other factors. Any modifications, equivalent replacements, improvements, etc. within the spirit and principle of the present disclosure shall fall within the protection scope of the present disclosure.

What is claimed is:

1. A method for face recognition, comprising:
obtaining an image to be recognized;
extracting an image feature of the image to be recognized;
obtaining a fused feature corresponding to a reference image of reference images, wherein the reference image of the reference images is a face image without a shielding object included, and wherein the fused feature corresponding to the reference image of the reference images is obtained by performing image feature fusion on the reference image and an enhanced image corresponding to the reference image, and the enhanced image corresponding to the reference image is obtained by arranging the shielding object in the reference image;
determining a similarity between the image feature of the image to be recognized and the fused feature corresponding to the reference image of the reference images to obtain a determination result of the similarity; and
determining, based on the obtained determination result of the similarity, a face recognition result of the image to be recognized.

2. The method according to claim 1, wherein the obtaining the fused feature corresponding to the reference image of the reference images comprises:
for the reference image of the reference images, obtaining a first image feature of the reference image;
obtaining a second image feature of the enhanced image corresponding to the reference image; and
performing, based on a weight ratio, weighted fusion on the first image feature and the second image feature to obtain the fused feature corresponding to the reference image.

3. The method according to claim 2, wherein the obtaining the second image feature of the enhanced image corresponding to the reference image comprises:
generating the enhanced image corresponding to the reference image; and
extracting the second image feature of the enhanced image corresponding to the reference image.

4. The method according to claim 3, wherein the generating the enhanced image corresponding to the reference image comprises:
locating a region for placement of the shielding object in the reference image;
determining a pixel content for the shielding object in a first image, wherein the first image is an image including the shielding object; and
replacing a pixel content in the region for the placement in the reference image with the pixel content for the shielding object to obtain the enhanced image corresponding to the reference image.

5. The method according to claim 2, further comprising:
before the performing, based on the weight ratio, weighted fusion on the first image feature and the second image feature to obtain the fused feature corresponding to the reference image, determining a target scenario for acquisition of the image to be recognized, wherein the target scenario is selected from at least one scenario for acquisition that is determined based on a wearing of the shielding object; and
determining, from a preset correspondence between each scenario of the at least one scenario for acquisition and a weight ratio of the scenario, a target weight ratio corresponding to the target scenario, wherein the weight ratio corresponding to each scenario of the at least one scenario for acquisition represents a weight ratio of an image feature of each reference image of the reference images to an image feature of the enhanced image of the reference image in the scenario; and
wherein the performing, based on the predetermined weight ratio, weighted fusion on the first image feature and the second image feature to obtain the fused feature corresponding to the reference image comprises:
performing, based on the target weight ratio, weighted fusion on the first image feature and the second image feature to obtain the fused feature corresponding to the reference image.

6. An electronic device, comprising:
at least one processor; and
a memory communicatively connected to the at least one processor, wherein the memory stores instructions executable by the at least one processor, wherein the instructions, when executed by the at least one processor, cause the at least one processor to perform actions including:
obtaining an image to be recognized;
extracting an image feature of the image to be recognized;
obtaining a fused feature corresponding to a reference image of reference images, wherein the reference image of the reference images is a face image without a shielding object included, and wherein the fused feature corresponding to the reference image of the reference images is obtained by performing image feature fusion on the reference image and an enhanced image corresponding to the reference image, and the enhanced image corresponding to the reference image is obtained by arranging the shielding object in the reference image;
determining a similarity between the image feature of the image to be recognized and the fused feature corresponding to the reference image of the reference images to obtain a determination result of the similarity; and
determining, based on the obtained determination result of the similarity, a face recognition result of the image to be recognized.

7. The electronic device according to claim 6, wherein the obtaining the fused feature corresponding to the reference image of the reference images comprises:
for the reference image of the reference images, obtaining a first image feature of the reference image;
obtaining a second image feature of the enhanced image corresponding to the reference image; and
performing, based on a weight ratio, weighted fusion on the first image feature and the second image feature to obtain the fused feature corresponding to the reference image.

8. The electronic device according to claim 7, wherein the obtaining the second image feature of the enhanced image corresponding to the reference image comprises:
generating the enhanced image corresponding to the reference image; and
extracting the second image feature of the enhanced image corresponding to the reference image.

9. The electronic device according to claim 8, wherein the generating the enhanced image corresponding to the reference image comprises:
locating a region for placement of the shielding object in the reference image;
determining a pixel content for the shielding object in a first image, wherein the first image is an image including the shielding object; and
replacing a pixel content in the region for the placement in the reference image with the pixel content for the shielding object to obtain the enhanced image corresponding to the reference image.

10. The electronic device according to claim 7, further comprising:
before the performing, based on the weight ratio, weighted fusion on the first image feature and the second image feature to obtain the fused feature corresponding to the reference image, determining a target scenario for acquisition of the image to be recognized, wherein the target scenario is selected from at least one scenario for acquisition that is determined based on a wearing of the shielding object; and
determining, from a preset correspondence between each scenario of the at least one scenario for acquisition and a weight ratio of the scenario, a target weight ratio corresponding to the target scenario, wherein the weight ratio corresponding to each scenario of the at least one scenario for acquisition represents a weight ratio of an image feature of each reference image of the reference images to an image feature of the enhanced image of the reference image in the scenario; and
wherein the performing, based on the predetermined weight ratio, weighted fusion on the first image feature and the second image feature to obtain the fused feature corresponding to the reference image comprises:
performing, based on the target weight ratio, weighted fusion on the first image feature and the second image feature to obtain the fused feature corresponding to the reference image.

11. A non-transitory computer-readable storage medium storing computer instructions, wherein the computer instructions, when executed by a computer, cause the computer to perform actions including:
obtaining an image to be recognized;
extracting an image feature of the image to be recognized;
obtaining a fused feature corresponding to a reference image of reference images, wherein the reference image of the reference images is a face image without a shielding object included, and wherein the fused feature corresponding to the reference image of the reference images is obtained by performing image feature fusion on the reference image and an enhanced image corresponding to the reference image, and the enhanced image corresponding to the reference image is obtained by arranging the shielding object in the reference image;
determining a similarity between the image feature of the image to be recognized and the fused feature corresponding to the reference image of the reference images to obtain a determination result of the similarity; and
determining, based on the obtained determination result of the similarity, a face recognition result of the image to be recognized.

12. The non-transitory computer-readable storage medium according to claim 11, wherein the obtaining the fused feature corresponding to the reference image of the reference images comprises:
for the reference image of the reference images, obtaining a first image feature of the reference image;
obtaining a second image feature of the enhanced image corresponding to the reference image; and
performing, based on a weight ratio, weighted fusion on the first image feature and the second image feature to obtain the fused feature corresponding to the reference image.

13. The non-transitory computer-readable storage medium according to claim 12, wherein the obtaining the second image feature of the enhanced image corresponding to the reference image comprises:
generating the enhanced image corresponding to the reference image; and
extracting the second image feature of the enhanced image corresponding to the reference image.

14. The non-transitory computer-readable storage medium according to claim 13, wherein the generating the enhanced image corresponding to the reference image comprises:
locating a region for placement of the shielding object in the reference image;
determining a pixel content for the shielding object in a first image, wherein the first image is an image including the shielding object; and
replacing a pixel content in the region for the placement in the reference image with the pixel content for the shielding object to obtain the enhanced image corresponding to the reference image.

15. The non-transitory computer-readable storage medium according to claim 12, further comprising:
before the performing, based on the weight ratio, weighted fusion on the first image feature and the second image feature to obtain the fused feature corresponding to the reference image, determining a target scenario for acquisition of the image to be recognized, wherein the target scenario is selected from at least one scenario for acquisition that is determined based on a wearing of the shielding object; and
determining, from a preset correspondence between each scenario of the at least one scenario for acquisition and a weight ratio of the scenario, a target weight ratio corresponding to the target scenario, wherein the weight ratio corresponding to each scenario of the at least one scenario for acquisition represents a weight ratio of an image feature of each reference image of the reference images to an image feature of the enhanced image of the reference image in the scenario; and
wherein the performing, based on the predetermined weight ratio, weighted fusion on the first image feature and the second image feature to obtain the fused feature corresponding to the reference image comprises:
performing, based on the target weight ratio, weighted fusion on the first image feature and the second image feature to obtain the fused feature corresponding to the reference image.
